(19) United States
(12) Patent Application Publication
(10) Pub. No.: US 2015/0136636 A1
(43) Pub. Date: May 21, 2015

(54) PACKAGE COMPRISING WATER-SOLUBLE FILM POUCHES FILLED WITH LIQUID WASHING OR CLEANING COMPOSITION

(71) Applicant: Henkel AG & Co. KGaA, Duesseldorf (DE)

(72) Inventors: Matthias Sunder, Duesseldorf (DE); Frank Meier, Duesseldorf (DE); Helmut Sandmueller, Monheim (DE); Frank Pessel, Duesseldorf (DE); Andreas Bauer, Kaarst (DE); Carsten Bertram, Duesseldorf (DE)

(21) Appl. No.: 14/606,289

(22) Filed: Jan. 27, 2015

Related U.S. Application Data
(63) Continuation of application No. PCT/EP2013/053339, filed on Feb. 20, 2013.

(30) Foreign Application Priority Data
Jul. 30, 2012 (DE) 10 2012 213 301.1

(51) Int. Cl. C11D 17/04; C11D 3/50

(52) U.S. Cl. CPC C11D 17/043; C11D 3/50
USPC 206/524.6

(57) ABSTRACT

The invention relates to a package (1) containing water-soluble film pouches (3) filled with liquid washing or cleaning agent (2), wherein the water-soluble film pouches (3) are entirely or in part formed from PVA copolymers and the water-soluble film pouch (3) and/or the washing and cleaning agent preparation contains a source of at least one amine compound, at least one scent emission source (4) which releases scents with a boiling point of >70° C. is arranged within the package, at least one ventilation orifice (5) is provided in the package (1), which ventilation orifice has, in magnitude terms, a ventilation orifice area/boiling point ratio relative to amine compounds of between 0.8 and 50 mm²/° C., preferably between 1 and 20 mm³/° C., more preferably between 1.1 and 10 mm²/° C.

### FIELD OF THE INVENTION

The present invention generally relates to a package containing water-soluble film pouches filled with liquid washing or cleaning agent.

### BACKGROUND OF THE INVENTION

A series of different presentations is known for washing and cleaning agent products. It is primarily freely dispensable liquid, granular and/or pulverulent preparations which have become established. From using freely dispensable preparations, consumers are used to smelling the scent of the preparation, which conventionally contains scent compositions, when opening the package containing the preparation.

There are, however, also portioned presentations such as for example tablets or film pouches. Film pouches filled with washing and cleaning agents are frequently formed from water-soluble films which has the advantage for the consumer that a corresponding pouch can be dispensed, for example into a washing machine, without having to open it. The problem frequently arises with this presentation that the scents of the preparations stored in the film pouch do not pass through the water-soluble films and therefore the consumer cannot identify the subsequent scent impression of the washed laundry directly from such a film pouch. A further drawback is that the water-soluble films and/or the washing and cleaning agents stored therein contain amine compounds which pass through the water-soluble film or are released thereby and result in a very distinctly perceptible malodor. This malodor is in particular perceived when a package filled with such film pouches is first opened.

It is therefore an object of the invention to provide a package for water-soluble film pouches which avoids or reduces the above-stated disadvantages.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A package (1) containing water-soluble film pouches (3) filled with liquid washing or cleaning agent (2), wherein the water-soluble film pouches (3) are entirely or in part formed from PVA and the water-soluble film pouch (3) and/or the washing and cleaning agent preparation comprise a source of at least one amine compound; at least one scent emission source (4) which releases scents with a boiling point of >70° C. is arranged within the package; and at least one ventilation orifice (5) is provided in the package (1), which ventilation orifice has, in magnitude terms, a ventilation orifice area/boiling point ratio relative to amine compounds of between 0.8 and 50 mm²/° C., preferably between 1 and 20 mm²/° C., more preferably between 1.1 and 10 mm²/° C.

### BRIEF DESCRIPTION OF THE DRAWINGS

The present invention will hereinafter be described in conjunction with the following drawing figures, wherein like numerals denote like elements, and

FIG. 1. Package containing loose water-soluble film pouches.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The object is achieved according to the invention in that a package containing water-soluble film pouches filled with liquid washing or cleaning agent is provided, wherein the water-soluble film pouches are entirely or in part formed from PVA, the washing or cleaning agent contains a source of at least one amine compound, at least one scent emission source which releases scents with a boiling point of >70° C. is arranged within the package, at least one ventilation orifice is provided in the package, which ventilation orifice has, in magnitude terms, a ventilation orifice area/boiling point ratio relative to amine compounds of between 0.8 and 50 mm²/° C., preferably between 1 and 20 mm²/° C., more preferably between 1.1 and 10 mm²/° C.

In one development of the package according to the invention, the water-soluble film pouch comprises at least one source of dimethylamine. In this connection it is more preferred for at least one ventilation orifice to be provided in the package, which ventilation orifice has, in magnitude terms, a ventilation orifice area/boiling point ratio relative to dimethylamine of 1.1-10 mm²/° C.

It is furthermore preferred for the package to be a plastics pouch. It is, however, also possible for the package to take the form of a plastics box.

According to an advantageous development of the package according to the invention, the ventilation orifice or ventilation orifices is/are arranged in the package above the filling level (H) of the film pouches.

It is furthermore preferred for between one and four ventilation orifices to be provided in the package.

It has finally also proved preferable for the scent emission source to be arranged on the bottom of the package.

### Water-Soluble Film Pouch

A water-soluble film pouch comprises a water-soluble envelope. The water-soluble envelope is preferably formed by a water-soluble film material.

The film pouch may be made dimensionally stable or deformable.

In a first preferred embodiment, the water-soluble film pouch takes dimensionally stable form, for example capsule or container form.

However, it is in principle also possible and preferred to shape the water-soluble film pouch as a non-dimensionally stable container, for example as a pouch. The shape of such a film pouch may be extensively adapted to the circumstances of use. Plastics films or sheets machined or processed into various shapes (such as tubes, cushions, cylinders, bottles, discs or the like) and other conceivable shapes may, for example, be considered. Films which are more preferred according to the invention are those which can be adhesively bonded and/or heat-sealed to form tubes, cushions or the like once they have been filled with washing or cleaning agent preparation.

The water-soluble package may have one or more chambers for storing one or more agents. The water-soluble package preferably has between 2 and 5 chambers.

It is preferred for the water-soluble envelope of the film pouch to contain polyvinyl alcohol or a polyvinyl alcohol copolymer. Water-soluble envelopes which contain polyvinyl alcohol or a polyvinyl alcohol copolymer have good stability combined with a sufficiently high water solubility, in particular cold water solubility.

The water-soluble envelope is preferably made of a water-soluble film material selected from the group consisting of polymers or polymer blends. The envelope may be formed of one or of two or more layers of the water-soluble film material. The water-soluble film material of the first layer and further layers, if present, may be identical or different.

It is preferred for the water-soluble envelope to contain polyvinyl alcohol or a polyvinyl alcohol copolymer.

Suitable water-soluble films for producing the water-soluble envelope are preferably based on a polyvinyl alcohol or a polyvinyl alcohol copolymer, the molecular weight of which is in the range from 10,000 to 1,000,000 gmol⁻¹, preferably from 20,000 to 500,000 gmol⁻¹, more preferably from 30,000 to 100,000 gmol⁻¹ and in particular from 40,000 to 80,000 gmol⁻¹.

Polyvinyl alcohol is conventionally produced by hydrolysis of polyvinyl acetate, since the direct synthetic pathway is not possible. The same is true of polyvinyl alcohol copolymers, which are accordingly produced from polyvinyl acetate copolymers. It is preferred for at least one layer of the water-soluble envelope to comprise a polyvinyl alcohol having a degree of hydrolysis of 70 to 100 mol %, preferably of 80 to 90 mol %, more preferably of 81 to 89 mol % and in particular of 82 to 88 mol %.

A polymer selected from the group comprising acrylic acid-containing polymers, polyacrylamides, oxazoline polymers, polystyrenesulfonates, polyurethanes, polyesters, polyether-polylactic acid or mixtures of the above polymers may additionally be added to a film material suitable for producing the water-soluble envelope.

In addition to vinyl alcohol, preferred polyvinyl alcohol copolymers comprise dicarboxylic acids as further monomers. Suitable dicarboxylic acids are itaconic acid, malonic acid, succinic acid and mixtures thereof, wherein itaconic acid is preferred.

In addition to vinyl alcohol, preferred polyvinyl alcohol copolymers likewise comprise an ethylenically unsaturated carboxylic acid, the salt thereof or the ester thereof. In addition to vinyl alcohol, such polyvinyl alcohol copolymers more preferably contain acrylic acid, methacrylic acid, acrylic acid esters, methacrylic acid esters or mixtures thereof.

Suitable water-soluble films for use in the envelopes of the water-soluble packages according to the invention are films which are distributed for example by MonoSol LLC for example under the names M8630, C8400 or M8900. Other suitable films comprise films known as Solublon® PT, Solublon® GA, Solublon® KC or Solublon® KL from Aicello Chemical Europe GmbH or VF-HP films from Kuraray.

A water-soluble pouch preferably has a length of between 50 and 80 mm, a width of between 40 and 70 mm and a height of between 15 and 45 mm. The capacity of the pouch is preferably between 20 and 50 ml. The surface area of a water-soluble pouch preferably amounts to between 5,000 and 10,000 mm².

It is furthermore preferred for between 10 and 100 water-soluble pouches to be stored in a packaging unit (pouch, box).

The capacity of the package preferably amounts to between 1 and 10 liters.

### Washing and Cleaning Agents For Storage In The Water-Soluble Pouch

One or a plurality of washing and cleaning agents is/are stored in the water-soluble film pouch. These washing and cleaning agents assume liquid to gel form.

In the case of washing or cleaning agent preparations which are present, suspensions or dispersions which are also conceivable and encompassed by the invention are those which can be provided alone, combined with other liquid detergent preparations or combined with solid detergent preparations in an individual enclosure or in a combination of a plurality of optionally interconnected enclosures.

The agent contains ingredients which do not destroy the structural integrity of the water-soluble envelope. If the agent used is a liquid washing or cleaning agent, it may contain one or more substances from the group of surfactants, builders, bleaching agents, enzymes, electrolytes, pH adjusting agents, perfumes, perfume carriers, fluorescent agents, dyes, hydrotropes, foam inhibitors, silicone oils, antiredeposition agents, graying inhibitors, shrinkage prevention agents, anticrease agents, dye transfer inhibitors, antimicrobial active substances, non-aqueous solvents, germicides, fungicides, antioxidants, preservatives, corrosion inhibitors, antistatic agents, bitter agents, ironing aids, waterproofing and impregnation agents, skin-conditioning active substances, antiswelling and antislip agents, softening components and UV absorbers.

The washing or cleaning agents may contain water, wherein the water content amounts to less than 10 wt. % and more preferably less than 8 wt. %, in each case relative to the total liquid washing or cleaning agent.

### Package

The package according to the invention comprises a closable container which is constructed to accommodate a plurality of water-soluble film pouches.

A container for the purposes of the present application is a device which is intended to enclose a plurality of water-soluble film pouches in such a manner that they are fit for shipping, storage and/or sale.

The container conventionally comprises a bottom and a circumferential surface which form a volume for accommodating the film pouch. The container furthermore has an orifice for removing the film pouches from the container, wherein the orifice is closable by a closure.

The container for accommodating the water-soluble film pouches preferably has the lowest possible water vapor permeability in order to protect the water-soluble film pouches stored therein from unwanted exposure to water vapor.

According to a first preferred embodiment, the container takes the form of a dimensionally stable container, for example the form of a closable box, can, bottle or carton.

It is in principle also possible to form the container as a non-dimensionally stable container, for example as a pouch or bag. It is in particular advantageous in this connection for the non-dimensionally stable container to take the form of a stand-up pouch.

The container is preferably formed from a plastics material. It is also possible to form the container from a cellulose-containing material such as for instance paper, cardboard or paperboard. It goes without saying that the container may also be produced from multilayer materials comprising plastics, cellulose-containing materials and/or metallic materials. Composite materials consisting of a cellulose-containing support material which is laminated with plastics and/or metallic films may be considered here.

Cans may in particular include ironed cans, ring-pull cans, friction top cans, necked-in cans, open-top cans, open-top vent-hole cans, interlocked sideseam cans, drawn cans, piston cans, convolute cans, tear-strip cans, beaded cans, lidded cans or stepped-rim cans.

A bottle may for example take the form of a see-through bottle, beer bottle, bocksbeutel, codd-neck bottle, German-type bottle, steinie bottle, stubby bottle, Vichy bottle, wide-necked bottle, as well as a meplat bottle, squeezy bottle, dropper bottle, or a packaging bottle such as for instance a perfume bottle.

A flexible container for the purposes of the present application is a packaging means which undergoes a substantial change in shape under even slight load when being properly used. The flexible packaging means in particular takes the form of a pouch.

The pouch may for example be selected from the group of flat-bottom pouches, block pouches, “brick” pouches, block-bottom pouches, “brick”-bottom pouches, stand-up pouches, bottom gusset pouches, cross-bottom pouches, round-bottom pouches, upright pouches, double-layer pouches window pouches, flat pouches, flap pouches, flap pocket pouches, conical pouches, tubular pouches, side gusset pouches, gusset pouches, sealed-edge pouches, 3-edge sealed pouches, double-seam pouches, turn-up flap pouches, carrier pouches and/or valve pouches.

### Ventilation Orifice

According to the invention, at least one ventilation orifice is provided in the package, which ventilation orifice has, in magnitude terms, a ventilation orifice area/boiling point ratio relative to amine compounds of between 0.8 and 50 mm²/° C., preferably between 1 and 20 mm²/° C., more preferably between 1.1 and 10 mm²/° C.

This ensures that the unwanted amine compounds can escape from the package through the ventilation orifices, while the desired scents remain in the package in order to have the scent effect desired by the consumer when the package is first opened.

The ventilation orifice area/boiling point ratio is obtained from the sum of the ventilation orifice areas in the otherwise closed package, relative to the boiling point of one or a group of amine compounds.

None of the ventilation orifice areas for the purposes of the present application are orifices for removing film pouches from the package. Ventilation orifices are consequently smaller than the film pouches stored in the package and therefore the film pouches cannot be removed through a ventilation orifice.

In the case of a group of amine compounds, the boiling point to be used for determining the ventilation orifice area/boiling point ratio is obtained from the amine compound which has the lowest boiling point and which is present in an amount of at least 5 wt. % in the relevant group of amine compounds.

The ventilation orifice may be introduced into the package for example by stamping, slitting or indeed also by melting by means of a hot needle.

The ventilation orifice or ventilation orifices is/are preferably arranged in the package above the filling level (H) of the film pouches.

It is furthermore preferred for between one and four ventilation orifices to be provided in the package.

It is also preferable for the ventilation orifice to have a basic shape which differs from the film pouches.

### Scent Emission Source

According to the invention, at least one scent emission source is arranged in the package. The scent emission source releases scents with a boiling point of >70° C.

In a preferred development of the invention, the scent emission source is arranged loose in the container, i.e. a user can if required remove it from the container. The scent emission source is preferably arranged on the bottom of the container.

The scent emission source may for example take the form of a scented paper or paperboard card. It is also conceivable, to manufacture scent carriers from other suitable materials, such as for example plastics or adhesive compositions.

The following exemplary embodiment illustrates the invention in greater detail.

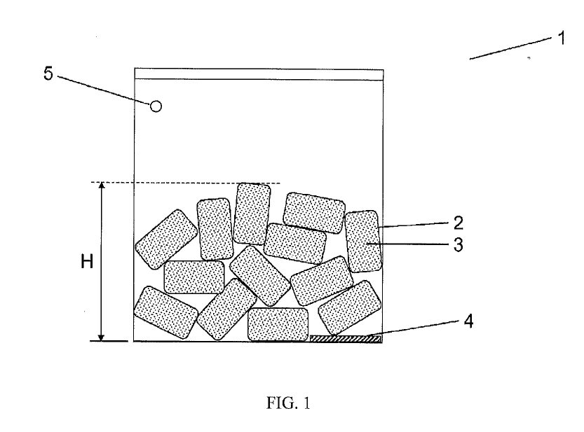

FIG. 1 Package containing loose water-soluble film pouches

FIG. 1 shows a package 1 which in the example shown takes the form of an upright pouch. In the interior of the package 1 are stored a plurality of loose film pouches 3 filled with liquid washing or cleaning agent 2.

The water-soluble film pouches 3 are formed from a PVA film, wherein the water-soluble film pouch 3 and/or the washing and cleaning agent preparation 2 comprises a source of at least one amine compound.

The film pouches 3 have a filling level H within the package. A ventilation orifice 5 is arranged above the filling level H.

### EXAMPLE

Stand-up pouches (capacity 2 liters) each containing 16 water-soluble film pouches (filled with 35 g), produced from water-soluble film M8630, 76 μm, from Monosol and optionally a scent card (40×40 mm, 1 mm thick) infused with perfume oil (with 75 mg Persil Stardust CB2 11-11366) were stored under different climatic conditions as shown in the following table. After opening, the pouch contents were immediately smelt by a panel of experts and the scent impression evaluated. Three ratings were used as the overall evaluation:

not OK—acceptable—OK.

The following results were obtained:

| Number/type of ventilation | | |
|---|---|---|
| orifices | 2 weeks @RT | 2 weeks @40° C. |
| without ventilation orifice, | strong amine note | strong amine note |
| with perfume card | strong solvent note | strong solvent note |
| | perfumed | perfumed |
| | not OK | not OK |
| without ventilation orifice, | strong amine note | strong amine note |
| without perfume card | strong solvent note | strong solvent note |
| | not OK | not OK |
| 1 × 3 mm diameter, without | no amine note | no amine note |
| perfume card | slight solvent note | slight solvent note |
| | acceptable | acceptable |
| 2 × 3 mm diameter, with | no amine note | no amine note |
| perfume card | slight solvent note | slight solvent note |
| | perfumed | perfumed |
| | OK | OK |
| 4 × 3 mm diameter, with | no amine note | no amine note |
| perfume card | slight solvent note | slight solvent note |
| | perfumed | perfumed |
| | OK | OK |
| 2 × 5 mm diameter, with | no amine note | no amine note |
| perfume card | slight solvent note | slight solvent note |
| | perfumed | perfumed |
| | OK | OK |
| 4 × 5 mm diameter, with | no amine note | no amine note |
| perfume card | slight solvent note | slight solvent note |
| | perfumed | perfumed |
| | OK | OK |

The ventilation orifices very distinctly reduce the solvent and amine notes, while the perfume odor produced by the scent card is retained.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A package (1) containing water-soluble film pouches (3) filled with liquid washing or cleaning agent (2), wherein
the water-soluble film pouches (3) are entirely or in part formed from PVA and
the water-soluble film pouch (3) and/or the washing and cleaning agent preparation comprise a source of at least one amine compound,
at least one scent emission source (4) which releases scents with a boiling point of >70° C. is arranged within the package,
at least one ventilation orifice (5) is provided in the package (1), which ventilation orifice has, a ventilation orifice area/boiling point ratio relative to amine compounds of between 0.8 and 50 mm²/° C.

2. The package according to claim 1, characterized in that the water-soluble film pouch (3) comprises at least one source of dimethylamine

3. The package according to claim 1, characterized in that the package (1) is a plastics pouch.

4. The package according to claim 1, characterized in that the package (1) is a plastics box.

5. The package according to one of the preceding claims, characterized in that the ventilation orifice (5) or ventilation orifices is or are arranged in the package (1) above the filling level (H) of the film pouches (2).

6. The package according to one of the preceding claims, characterized in that between one and four ventilation orifices (5) is or are provided in the package (1).

7. The package according to one of the preceding claims, characterized in that the scent emission source (5) is arranged on the bottom of the package (1).
